(19) United States
(12) Patent Application Publication
(10) Pub. No.: US 2004/0189090 A1
(43) Pub. Date: Sep. 30, 2004

(54) Power line communication device for vehicle

(75) Inventors: Yo Yanagida, Shizuoka-ken (JP); Terumitsu Sugimoto, Shizuoka-ken (JP)

Correspondence Address: Finnegan, Henderson, Farabow,, Garrett & Dunner, L.L.P., 1300 I Street, N.W., Washington, DC, 20005-3315, US

(73) Assignee: YAZAKI CORPORATION

(21) Appl. No.: 10/652,204

(22) Filed: Sep. 2, 2003

(30) Foreign Application Priority Data
Sep. 3, 2002 (JP) P2002-257575

(51) Int. Cl. B60L 3/00

(52) U.S. Cl. 307/10.1

(57) ABSTRACT

A power line communication device for a vehicle detects a communication signal received through a power line and extracts incoming data composed of a digital signal. The device dulls a waveform of the digital signal of the incoming data by use of a resistor and a capacitor, and thereby converts the incoming data into an analog signal. Thereafter, the device converts the analog signal into a digital signal by use of an inverter circuit based on a given threshold level, and thereby subjects the incoming data to waveform shaping.

### BACKGROUND OF THE INVENTION

1. Field of the Invention

This invention relates to a power line communication device for a vehicle configured to superimpose various signals used in a vehicle on direct-current power in a power line to perform communication.

2. Description of the Related Art Performance of automobiles continues to advance in recent years, and an automobile today is equipped with many electronic control units (ECUs). The ECUs are provided not only to control an engine and a transmission, but also to control power windows, lamps, side mirrors, and the like. Each ECU operates in relation to one another. Accordingly, the ECUs are mutually connected through exclusive signal lines provided between the ECUs and through a common bus to the ECUs, and signals are inputted and outputted through the signal lines and through communication lines in the bus.

Recently, the number of communication lines connecting between the ECUs tends to be increased due to an increase in the number of ECUs to be equipped in an automobile or an increase in the number of signals associated with more intricate control. Such an increase in the number of the communication lines raises a problem of an increase in size and cost of a wiring harness including the communication lines.

In order to solve this problem, technology has been developed in which communication among ECUs is performed by means of superimposing signals inputted to and outputted from the ECUs on direct-current power in a power line for supplying electricity to the ECUs (see Japanese Unexamined Patent Publication No. 7(1995)-50619). This technology reduces the number of communication lines and thereby solves the above-mentioned problem.

### SUMMARY OF THE INVENTION

FIG. 1 is a view schematically showing a configuration of an ECU 100 which is now on file. In FIG. 1, a power supply voltage for a vehicle to be supplied though a power line 102 to which a bypass capacitor 101 is connected for suppressing voltage fluctuation, for example, a 12 V power supply voltage is converted into an operating power source voltage for electronic devices inside the vehicle, for example, at 5 V by a power source circuit 103 including a regulator and then is supplied to the electronic devices inside the vehicle. A load controller 104 including switching elements such as relays is switch-controlled based on a load control signal to control a load drive current which is provided to a load 105 through the power line 102. The load 105, such as a lamp or a drive motor for a power window, a side mirror or the like, is driven by the drive current provided from the power line 102 via the load controller 104. To the power line 102, connected is a power line communication device for a vehicle (hereinafter referred to as a PLC) 106 which superimposes signals on the direct-current power in the power line 102 to perform communication between the ECUs.

When the ECU 100 receives a communication signal, the communication signal modulated and superimposed on the direct-current power in the power line 102 is provided to a comparator 108 through a bandpass filter 107. The communication signal provided to the comparator 108 is compared with a standard level for comparison and then amplified. The amplified communication signal is detected by a detector 109 to obtain incoming data composed of a digital signal. The obtained incoming data are provided to a processor 110 for executing various processes, and the load control signal is generated in one of the processes and provided to the load controller 104.

On the other hand, when the ECU 100 transmits the communication signal, outgoing data generated by the processor 110 are provided to a modulator 111. The outgoing data provided to the modulator 111 are modulated together with a carrier wave oscillated by a carrier wave oscillator 112. The modulated outgoing data are provided to the power line 102 via an output part 113 and superimposed on the direct-current power in the power line 102 for transmission.

In the ECU 100 which is now on file, the direct-current power in the power line 102 is supplied to the load via the load controller 104. Accordingly, when the load 105 is driven, the PLC 106 is connected to the load 105 through the power line 102. Therefore, noises generated by the load 105, such as motor noises generated by a drive motor for a power window, are provided to the power line 102 which supplies the operating power source voltage to the load. Due to such a restrictive condition of a circuit configuration, the noises provided to the power line 102, such as short-pulse noises shown in FIG. 2, break into the PLC 106 through the power line 102.

The noises breaking into the PLC 106 adversely affect demodulation of the communication signal received by the PLC 106 and cause defects in the incoming data composed of a digital signal to be outputted from the detector 105, as shown in FIG. 3, for example. Specifically, a short-pulse signal drop (indicated with “a” in the drawing) may occur in a signal portion which is normally supposed to represent data “1”; a short-pulse noise (indicated with “b” in the drawing) may occur in a signal portion which is normally supposed to represent data “0”.

If the defects occur in the incoming data, a read error of the incoming data occurs when the processor 110 receives and processes the incoming data. As a consequence, the defects cause a higher communication error rate. Moreover, the occurrence of the read error of the incoming data leads to incapability of performing accurate processing based on the incoming data.

The present invention has been made in view of the above-mentioned circumstances. An object of the present invention is to provide a power line communication device for a vehicle which can remove noises from incoming data after detection and thereby lower a communication error rate.

To achieve the above object, the present invention provides a power line communication device for a vehicle which is included in an electronic control unit and configured to transmit and receive communication signals between the electronic control units. The electronic control unit is connected to a power line for supplying direct-current power to a vehicle and configured to receive a communication signal superimposed on the direct-current power in the power line, to superimpose a generated communication signal on the direct-current power in the power line to transmit the communication signal, thereby controlling each function of the vehicle. Here, the power line communication device for a vehicle includes: a detector configured to detect the communication signal received through the power line and to extract incoming data composed of a digital signal, and a waveform shaper connected to the detector and configured to subject the incoming data to waveform shaping by dulling a signal waveform of the incoming data to convert the incoming data into an analog signal and by converting the analog signal into a digital signal based on a given threshold.

According to the present invention, the incoming data after detection are subjected to waveform shaping by the waveform shaper. Therefore, it is possible to remove a short-pulse signal drop and a short-pulse noise, which are attributable to noises inputted by a load through the power line, from the incoming data. In this way, it is possible to accurately receive the communication signal and obtain the incoming data, and to achieve a decline in a communication error rate. Moreover, a read error of the incoming data is prevented to allow accurate processing based on the incoming data.

In a preferred aspect of the present invention, the signal waveform of the incoming data is integrated and converted into the analog signal.

According to this aspect, since the digital waveform of the incoming data is converted into an integral waveform, it is possible to easily remove a short-pulse signal drop and a short-pulse noise, which are attributable to noises inputted by a load through the power line, from the incoming data.

In a preferred aspect of the present invention, the waveform shaper includes a low-pass filter of which an input end is connected to an output end of the detector and which is configured to integrate the signal waveform of the incoming data, and a logic circuit of which an input end is connected to an output end of the low-pass filter and which is configured to convert an integral waveform into a digital waveform by use of the given threshold.

According to this aspect of the present invention, a high-frequency component of the incoming data is removed by the low-pass filter and the logic circuit. Therefore, it is possible to easily remove a short-pulse signal drop and a short-pulse noise, which are attributable to noises inputted by a load through the power line, from the incoming data.

In a preferred aspect of the present invention, the low-pass filter includes a resistor of which one end is connected to the output end of the detector and another end is connected to the input end of the logic circuit, and a capacitor of which one end is grounded and another end is connected to the other end of the resistor and to the input end of the logic circuit.

According to this aspect, the waveform shaper is comprised of the resistor, the capacitor, and the logic circuit. Therefore, it is possible to realize the simple waveform shaper of a small size and at low costs.

In a preferred aspect of the present invention, the logic circuit is a comparator having a hysteresis.

According to this aspect, it is possible to prevent chattering of an output signal even if the integral waveform of the incoming data includes some swings in the vicinity of the threshold.

In a preferred aspect of the present invention, the threshold value is set to an intermediate value of at least one of an operating power source voltage for driving a load in a vehicle and amplitude of the incoming data.

According to this aspect, since the threshold is set to the intermediate value of either the operating power source voltage for driving the load in the vehicle or the amplitude of the incoming data, the integral waveform of the incoming data is converted into an appropriate digital waveform.

In a preferred aspect of the present invention, the threshold is set to 2.5 V.

According to this aspect, when the operating power source voltage for driving the load in the vehicle or the amplitude of the incoming data is 12 V, it is possible to appropriately conduct waveform shaping of the incoming data.

### BRIEF DESCRIPTION OF THE DRAWINGS

FIG. 1 is a view showing a configuration of an electronic control unit (ECU), which is now on file, including a power line communication device for a vehicle (PLC).

FIG. 2 is a graph showing an example of noises provided from a load to a power line.

FIG. 3 is a graph showing a signal waveform after detection.

FIG. 4 is a view showing a configuration of an ECU which includes a power line communication device for a vehicle (PLC) according to an embodiment of the present invention.

FIG. 5 is a view showing a configuration of a waveform shaper.

FIG. 6 is a graph showing an input signal waveform in an inverter circuit constituting the waveform shaper.

FIG. 7 is a graph showing a signal waveform of incoming data after waveform shaping.

### DETAILED DESCRIPTION OF THE PREFERRED EMBODIMENTS

Hereinafter, an embodiment of this invention will be described with reference to the accompanying drawings.

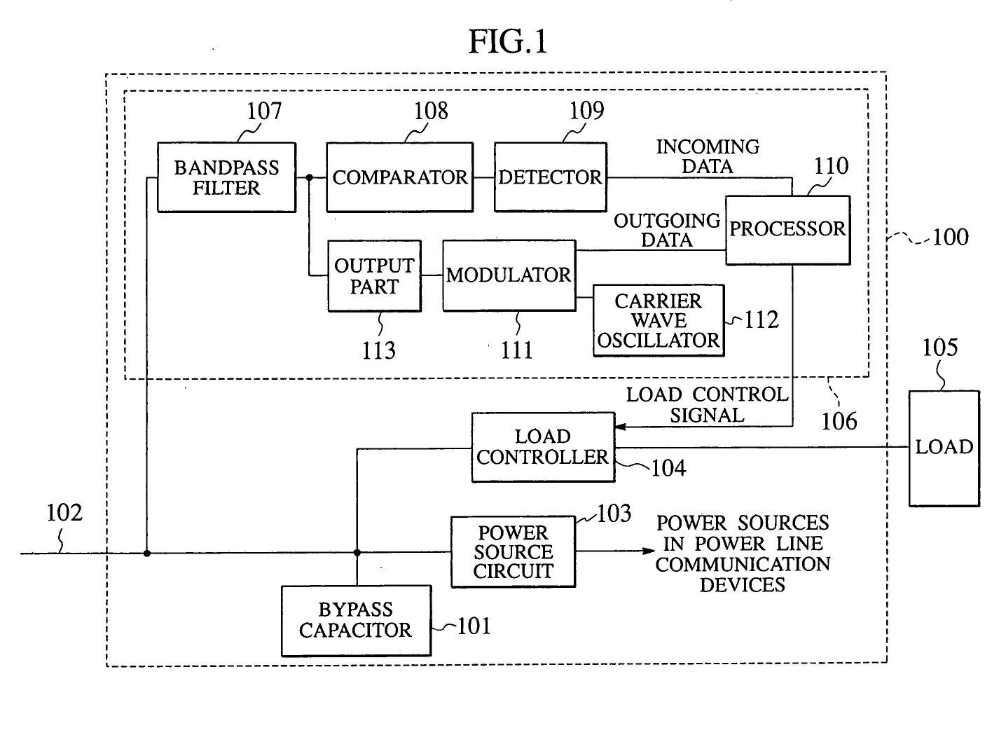

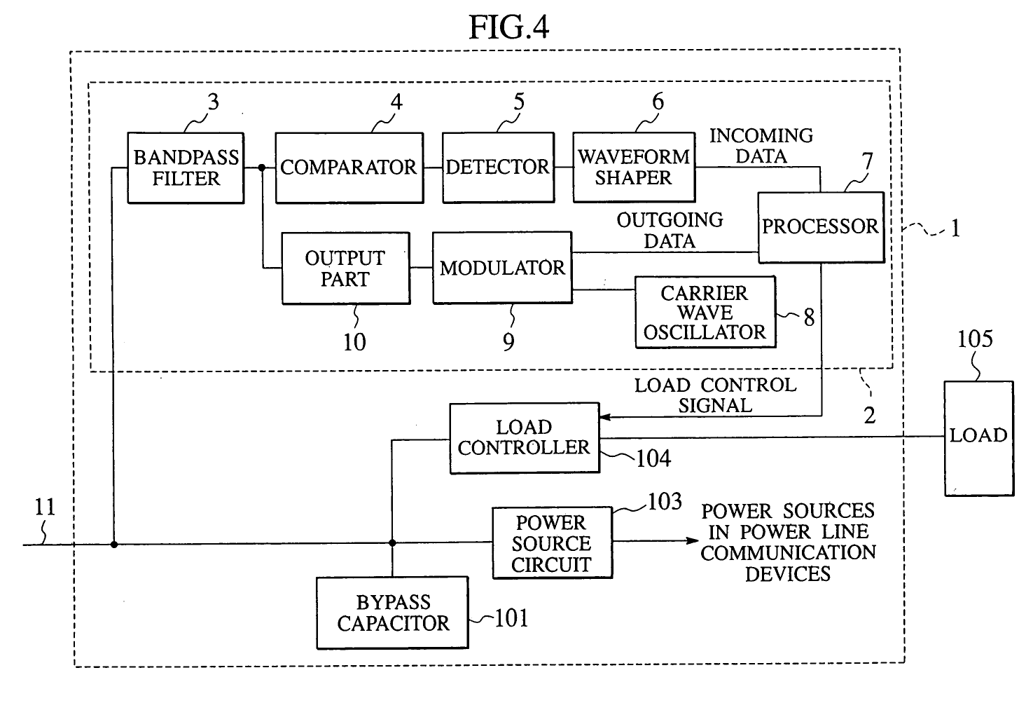

FIG. 4 is a view showing a configuration of an electronic control unit (ECU) which includes a power line communication device for a vehicle (PLC) according to an embodiment of the present invention. An ECU 1 includes a PLC 2, a bypass capacitor 101, a power source circuit 103, and a load controller 104. The bypass capacitor 101, the power circuit 103, and the load controller 104 have similar functions to those shown in FIG. 1, and description thereof will be omitted herein. The PLC 2 includes a bandpass filter 3, a comparator 4, a detector 5, a waveform shaper 6, a processor 7, a carrier wave oscillator 8, a modulator 9, and an output part 10.

A communication signal to be superimposed on direct-current power in a power line 11 for supplying a power source voltage to a vehicle and to be communicated between the ECUs is inputted to the bandpass filter 3. The bandpass filter 3 substantially removes low-frequency and high-frequency noise components from the inputted communication signal. The communication signal after removing the noise components is provided to a comparator 4. Here, the communication signal (digital signal) to be communicated between the ECUs is subjected to amplitude shift keying (ASK) modulation into a higher frequency and transmitted to the power line 11 as described later.

The comparator 4 amplifies the communication signal by comparing the communication signal provided from the bandpass filter 3 with a standard level for comparison. The communication signal thus amplified is provided to the detector 5.

The detector 5 detects the communication signal amplified by the comparator 4 and extracts incoming data composed of a digital signal. The incoming data thus extracted are provided to the waveform shaper 6.

The waveform shaper 6 removes a short-pulse signal drop and a short-pulse noise as shown in FIG. 3 from the incoming data by subjecting the incoming data extracted by the detector 5 to waveform shaping. The short-pulse noise is attributable to a noise which the bandpass filter 3 failed to remove. The incoming data after removing the signal drop and the noise are provided to the processor 7.

The processor 7 includes a computer such as a central processing unit (CPU) and performs various processes based on the incoming data. The processor 7 generates a load control signal for controlling the load controller 104 in one of the various processes executed based on the incoming data. The generated load control signal is provided to the load controller 104. The load controller 104 is controlled, as described above, based on this load control signal. Moreover, the processor 7 generates outgoing data to be transmitted to other ECUs. The generated outgoing data are provided to the modulator 9.

The carrier wave oscillator 8 oscillates a carrier wave used at the time of superimposing the outgoing data on the direct-current power in the power line 11 and transmitting the outgoing data. The oscillated carrier wave is provided to the modulator 9.

The outgoing data generated by the processor 7 and the carrier wave oscillated by the carrier wave oscillator 8 are inputted to the modulator 9. The modulator 9 subjects the outgoing data to amplitude shift keying (ASK) modulation. The modulated outgoing data are provided to the output part 10.

In multiplex communication realized by superimposing the communication signal (baseband) on the direct-current power in the power line 11, if the carrier wave has a low frequency in a range, for example, from several hundred hertz to several kilohertz, the communication signal is significantly attenuated by a bypass capacitor mounted on an electronic device connected to a power source. Therefore, the attenuation of the communication signal attributable to the bypass capacitor is suppressed by subjecting the communication signal to the ASK modulation at a high frequency of several megahertz (2.5 MHz, for example), and power line communication can be stably performed. Moreover, the ASK modulation can be realized by a simple constitution and at a low cost in comparison with other modulation methods.

The output part 10 amplifies the ASK-modulated outgoing data and outputs the data to the power line 11 via the bandpass filter 3.

In the above-described configuration, when the ECU 1 receives the communication signal, the communication signal superimposed on the direct-current power in the power line 11 is provided to the comparator 4 via the bandpass filter 3. Then, the communication signal is compared with the standard level for comparison and amplified by the comparator 4. The amplified communication signal is detected by detector 5 to obtain the incoming data. The obtained incoming data are provided to the waveform shaper 6 and subjected to wave shaping, thereby removing a short-pulse signal drop and a short-pulse noise from the incoming data. The incoming data from which the signal drop and the noise are removed are provided to the processor 7 and subjected to various processes.

On the other hand, when the ECU 1 transmits the communication signal, the outgoing data generated by the processor 7 are provided to the modulator 9 and subjected to the ASK modulation into a high-frequency signal in a bandwidth of several megahertz together with the carrier wave oscillated by the carrier wave oscillator 8. The ASK-modulated outgoing data are provided to the power line 11 via the output part 10 and superimposed on the direct-current power in the power line 11 to be transmitted.

The power supply voltage provided to the power line 11, e.g., a 12-V direct-current voltage is supplied to the power source circuit 103 and then converted into, for example, 5 V by the power source circuit 103 as an operating power supply voltage for electronic devices provided inside the vehicle, for example. The power supply voltage converted into 5 V is supplied to the electronic devices as the power supply. Meanwhile, the power supply voltage provided to the power line 11 is supplied to the load controller 104. The power supply voltage provided to the load controller 104 is supplied to a load 105 by the load controller 104 at the time of driving the load 105, whereby the load 105 is driven by the supplied voltage.

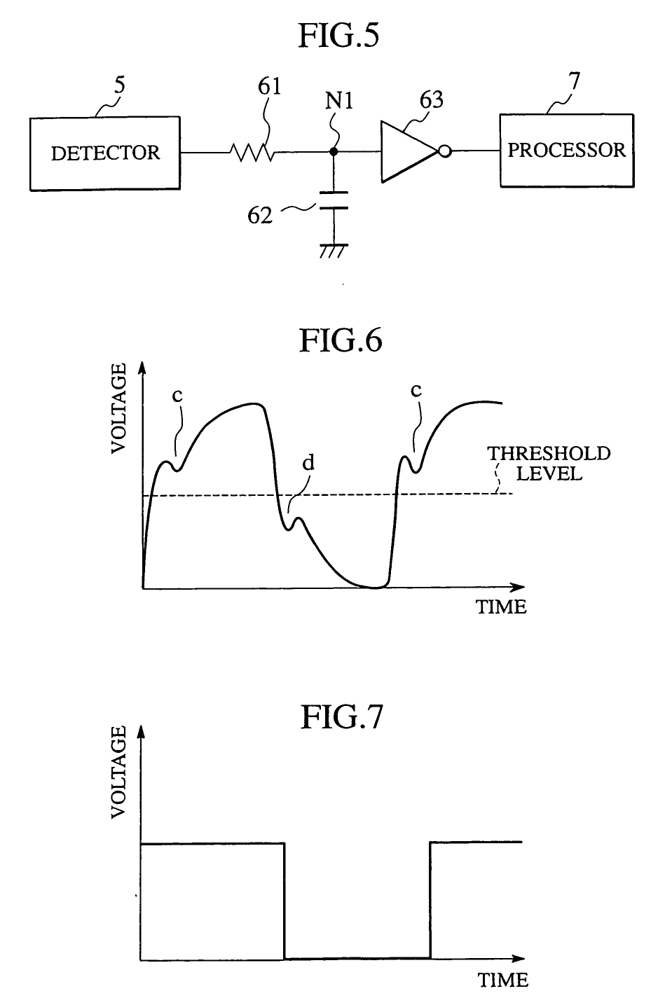

FIG. 5 is a view showing a configuration of the waveform shaper 6.

The waveform shaper 6 includes a resistor 61, a capacitor 62, and an inverter circuit 63 such as a CMOS logic circuit. One end of the resistor 61 is connected to an output end of the detector 5, and the other end thereof is connected to an input end of the inverter circuit 63. One end of the capacitor 62 is connected to the other end of the resister 62 and the input end of the inverter circuit 63, and the other end thereof is grounded.

The input end of the inverter circuit 63 is connected to the other end of the resistor 61 and the one end of the capacitor 62, and an output end thereof is connected to an input end of the processor 7. In the inverter circuit 63, a threshold level is set to an intermediate level (about 2.5 V) of either an operating power supply voltage Vcc (5 V, for example) or amplitude (0 to 5 V, for example) of the incoming data provided from the detector 5.

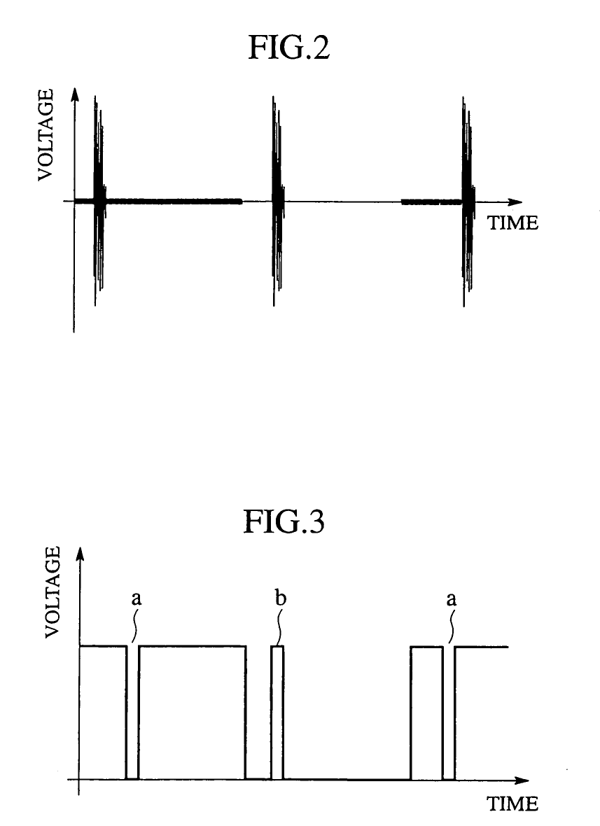

In the configuration described above, when the noises as shown in FIG. 2 break into the power line 11, the incoming data including the short-pulse signal drop and the short-pulse noise as shown in FIG. 3 are outputted from the detector 6 and thereby provided to the waveform shaper 6, the incoming data are converted into a dull signal waveform due to operations of the resistor 61 and the capacitor 62. In other words, the signal waveform at a junction N1 of the resistor 61, the capacitor 62 and the input end of the inverter circuit 63 is converted into an integral waveform as shown in FIG. 6, for example. The short-pulse signal drops indicated with “a” in FIG. 3 and the short-pulse noise indicated with “b” therein are converted into signal waveforms as indicated with “c” (positions corresponding to “a” in FIG. 3) and with “d” (a position corresponding to “b” in FIG. 3) in FIG. 6 by dulling the signal waveform of the incoming data.

When the integral waveform as shown in FIG. 6 is converted into a digital signal by passing the waveform through the inverter circuit 63 which has the threshold level being set to the intermediate level of the operating power supply voltage, the portions indicated with “c” and “d” in FIG. 6 are recognized as digital signals “1” and “0”, respectively. As a result, it is possible to obtain the incoming data having the signal waveform including “0” and “1” as shown in FIG. 7. In other words, by subjecting the incoming data after detection to waveform shaping using the waveform shaper 6, it is possible to remove the short-pulse signal drops and the short-pulse noise from the incoming data shown in FIG. 3 which include the short-pulse signal drops and the short-pulse noise.

In this way, even if noises generated at the time of driving the load break into the PLC 2 through the power line 11, it is still possible to accurately detect the communication signal and to obtain the incoming data. Therefore, it is possible to lower a communication error rate. Moreover, a read error of the incoming data is prevented, and the processor 7 can execute accurate processing based on the incoming data. Meanwhile, the waveform shaper 6 is comprised of the resistor 61, the capacitor 62, and the inverter circuit 63. Accordingly, it is possible to realize the simple waveform shaper 6 of a small size and at low costs.

Note that, in order to obtain the smooth digital waveform, the waveform shaper 6 applies an RC low-pass filter including the resistor 61 and the capacitor 62 to convert the digital waveform into the integral waveform in the first half of the waveform shaping process. However, it is possible to apply another filter such as an active filter, which is a high-degree low-pass filter, instead of the RC low-pass filter as long as the filter can convert the digital waveform into an integral waveform.

Moreover, in order to obtain the smooth digital waveform, the waveform shaper 6 applies the inverter circuit 63 to reconvert the integral waveform into the digital waveform in the second half of the waveform shaping process. However, it is possible to apply another logic circuit such as a buffer circuit, a logical multiplication circuit or a logical sum circuit instead of the inverter circuit as long as the circuit can convert the integral waveform shown in FIG. 6 into a digital signal by use of a threshold level of a CMOS logic circuit.

Furthermore, when the integral waveform generated in the first half of the waveform shaping process includes some swings in the vicinity of the threshold level, it is also possible to apply a comparator having a hysteresis, such as a Schmidt trigger circuit, instead of the inverter circuit 63 in order to prevent chattering of an output signal.

What is claimed is:

1. A power line communication device for a vehicle which is included in an electronic control unit and configured to transmit and receive communication signals between the electronic control units, the electronic control unit being connected to a power line for supplying direct-current power to a vehicle and configured to receive a communication signal superimposed on the direct-current power in the power line, to superimpose a generated communication signal on the direct-current power in the power line to transmit the communication signal, and to thereby control each function of the vehicle, the power line communication device for a vehicle comprising:
a detector configured to detect the communication signal received through the power line and to extract incoming data including a digital signal; and
a waveform shaper connected to the detector and configured to subject the incoming data to waveform shaping by dulling a signal waveform of the incoming data to convert the incoming data into an analog signal and by converting the analog signal into a digital signal based on a given threshold.

2. The power line communication device for a vehicle according to claim 1, wherein the signal waveform of the incoming data is integrated and converted into the analog signal.

3. The power line communication device for a vehicle according to claim 2, wherein the waveform shaper comprises:
a low-pass filter of which an input end is connected to an output end of the detector and which is configured to integrate the signal waveform of the incoming data; and
a logic circuit of which an input end is connected to an output end of the low-pass filter and which is configured to convert an integral waveform into a digital waveform by use of the given threshold.

4. The power line communication device for a vehicle according to claim 3, wherein the low-pass filter comprises:
a resistor of which one end is connected to the output end of the detector and another end is connected to the input end of the logic circuit; and
a capacitor of which one end is grounded and another end is connected to the other end of the resistor and to the input end of the logic circuit.

5. The power line communication device for a vehicle according to claim 3, wherein the logic circuit is a comparator having a hysteresis.

6. The power line communication device for a vehicle according to claim 3, wherein the threshold value is set to an intermediate value of at least one of an operating power source voltage for driving a load in a vehicle and amplitude of the incoming data.

7. The power line communication device for a vehicle according to claim 6, wherein the threshold is set to 2.5 V.
